(19) United States
(12) Patent Application Publication
(10) Pub. No.: US 2012/0171106 A1
(43) Pub. Date: Jul. 5, 2012

(54) CARBON NANOTUBE GROWTH VIA CHEMICAL VAPOR DEPOSITION USING A CATALYTIC TRANSMEMBRANE TO SEPARATE FEEDSTOCK AND GROWTH CHAMBERS

(75) Inventors: Delmar L. Barker, Tucson, AZ (US); W. Howard Poisl, Tucson, AZ (US); Brian J. Zelinski, Tucson, AZ (US); Jon N. Leonard, Tucson, AZ (US)

(73) Assignee: Raytheon Company

(21) Appl. No.: 11/969,533

(22) Filed: Jan. 4, 2008

(51) Int. Cl. D01F 9/12; B01J 19/12; B82Y 35/00; B82Y 40/00; B82Y 30/00

(52) U.S. Cl. 423/447.3; 422/222; 422/186; 204/157.4; 977/742; 977/843

(57) ABSTRACT

A system and method for growing nanotubes out of carbon and other materials using CVD uses a catalytic transmembrane to separate a feedstock chamber from a growth chamber and provide catalytic material with separate catalytic surfaces to absorb carbon atoms from the feedstock chamber and to grow carbon nanotubes in the growth chamber. The catalytic transmembrane provides for greater flexibility to independently control both the gas environment and pressure in the chambers to optimize absorption and carbon growth and to provide instrumentation in the growth chamber for in-situ control of defects or observation of the carbon nanotube growth.

### BACKGROUND OF THE INVENTION

1. Field of the Invention

This invention relates to nanotube (NT) growth of carbon and other materials using a chemical vapor deposition (CVD) process.

2. Description of the Related Art

Carbon nanotubes (CNTs) have stimulated a great deal of interest in the microelectronic and other industries because of their unique properties including tensile strengths above 35 GPA, elastic modulus reaching 1 TPa, higher thermal conductivity than diamond, ability to carry 1000× the current of copper, densities below 1.3 g/cm³ and high chemical, thermal and radiation stability. CNTs have great promise for devices such as field effect transistors, field emission displays, single electron transistors in the microelectronic industry, and uses in other industries. Commercialization of CNTs will depend in large part on the ability to grow and network CNTs on a large cost-effective scale without compromising these properties.

As illustrated in FIG. 1, a CNT 10 is a hollow cylindrical shaped carbon molecule. The cylinderical structure is built from a hexagonal lattice of sp² bonded carbon atoms 12 with no dangling bonds. The properties of single-walled nanotubes (SWNTs) are determined by the graphene structure in which the carbon atoms are arranged to form the cylinder. Multi-walled nanotubes (MWNTs) are made of concentric cylinders around a common central hollow.

CNTs are commonly grown using several techniques such as arc discharge, laser ablation and chemical vapour deposition (CVD). In CVD the growth of a CNT is determined by the presence of a catalyst, usually a transition metal such as Fe, Co or Ni, which causes the catalytic dehydrogenation of hydrocarbons and consequently the formation of a CNT. CVD generally produces MWNTs or SWNTs of relatively poor quality due mostly to the poorly controlled diameters of the nanotubes. T However, CVD is relatively easy to scale up and can be integrated with conventional microelectronic fabrication, which favors commercialization.

The way in which nanotubes are formed is not precisely known. The growth mechanism is still a subject of scientific debate, and more than one mechanism might be operative during the formation of CNTs. As shown in FIGS. 2a and 2b, a catalyst 20 is deposited on a support such as porous silicon 22. At elevated temperatures, exposure to a carbon containing gas causes the catalyst to take in carbon, on either the surfaces, into the bulk, or both. A precursor to the formation of nanotubes and fullerenes, C₂, is formed on the surface of the catalyst. From this precursor, a rodlike carbon 24 is formed rapidly, followed by a slow graphitisation of its wall. The CNT can form either by ‘extrusion’ (also know as ‘base growth’) shown in FIG. 2a, in which the CNT grows upwards from the catalyst that remains attached to the support, or the particles can detach and move at the head of the growing nanotube, labelled ‘tip-growth’, as shown in FIG. 2b. Depending on the size of the catalyst particle either SWNT or MWNT are grown.

As shown in FIG. 3, to synthesize CNTs 24 using CVD the support 22 and catalytic material 20 are placed inside an environmentally-controlled chamber 32. A plurality of gas feeds 34 introduce a process gas including a mixture of a carbon-containing growth gas 36, typically a hydrocarbon CₓH_{y} such as Ethylene (C₂H₄), Methane (CH₄), or Acetylene (C₂H₂) or possibly a non-hydrocarbon such as carbon-monoxide (CO), a buffer gas 38 such Argon (Ar) to control pressure inside the chamber and prevent released hydrogen atoms from exploding and possibly a scrubber gas 40 such as H₂O or O₂ to periodically clean the surface of the catalyst. An energy source 42 such as a heating coil provides the energy necessary to heat the catalyst to a temperature which allows it to ‘crack’ the hydrocarbon molecules into reactive atomic carbon 44. The reactive carbon 44 is absorbed into the surface of catalytic material 20 causing the CNT to grow from the same catalytic surface. A pump system 46 including a vacuum and/or pressure pump controls the pressure inside the chamber to produce conditions both conducive to absorption of carbon atoms into the catalytic material and growth of CNTs from the catalytic material. A number of electrical ports 48 are provided to accommodate pressure sensors, thermocouples and the like to monitor conditions inside the chamber.

### SUMMARY OF THE INVENTION

The present invention provides a system and method for growing nanotubes out of carbon and other materials using a CVD process that facilitates sustained rapid growth of high quality nanotubes with greater control over the geometry of the nanotubes and arrays of nanotubes, the ability to control defects in the nanotubes and the capability to observe nanotube growth using electron gun and optical equipment in-situ.

This is accomplished with a catalytic transmembrane that separates a feedstock chamber from a growth chamber and provides a catalyst with separate catalytic surfaces to absorb carbon atoms from the feedstock chamber and to grow carbon nanotubes in the growth chamber. Separation of the feedstock and growth chambers and of the absorption and growth surfaces provides for greater flexibility to independently control both the gas environment and pressure in the chambers to optimize absorption and growth and to provide instrumentation in the growth chamber for in-situ control of defects or observation of the carbon nanotube growth.

These and other features and advantages ofthe invention will be apparent to those skilled in the art from the following detailed description of preferred embodiments, taken together with the accompanying drawings, in which:

### BRIEF DESCRIPTION OF THE DRAWINGS

FIG. 1, as described above, is a diagram of a carbon nanotube;

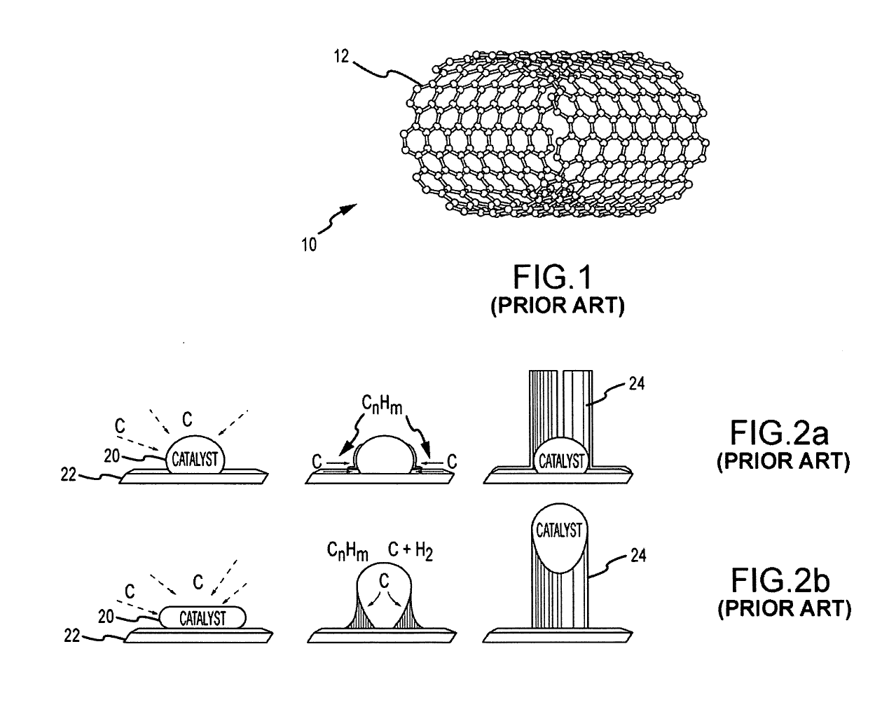

FIGS. 2a-2b, as described above, are diagrams illustrating root and tip CNT growth;

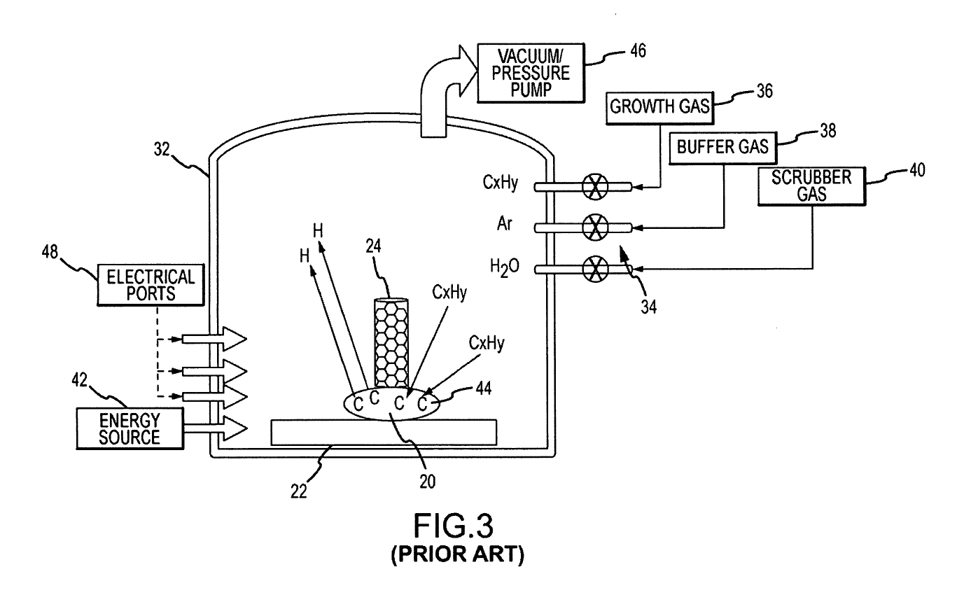

FIG. 3, as described above, is a diagram of a conventional CVD process using a single feedstock-growth chamber to grow CNTs on a substrate;

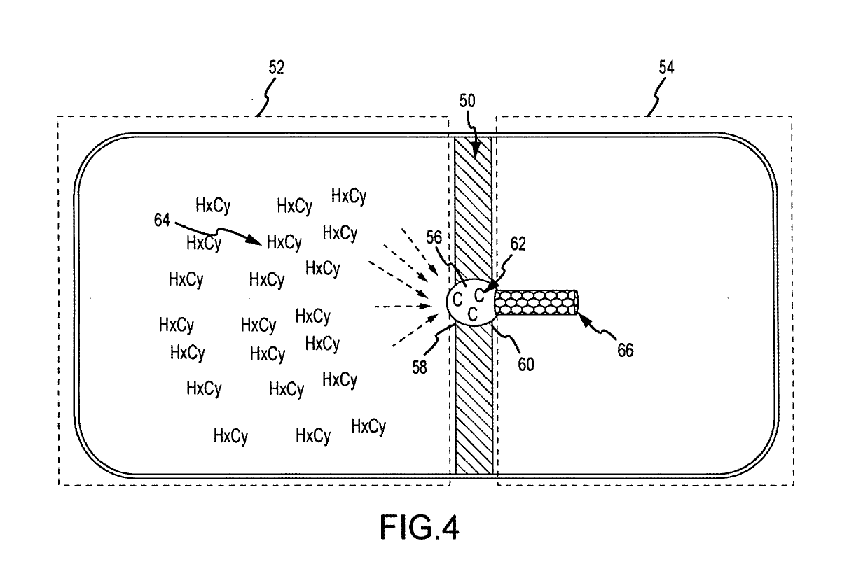

FIG. 4 is a simplified diagram of a CVD process using a catalytic transmembrane to separate the feedstock and growth chambers and control CNT growth in accordance with the present invention;

FIG. 5 is a diagram of an exemplary embodiment of the CVD process using a catalytic transmembrane to separate the feedstock and growth chambers in accordance with the present invention;

FIG. 6 is a diagram of an exemplary embodiment of a gasket that seals the feedstock and growth chambers from the external environment and each other;

FIGS. 7a and 7b are section and plan views of an exemplary catalytic transmembrane including an array of catalytic nano-particles in membrane pores;

FIGS. 8a through 8g are diagrams of an exemplary process for fabricating the catalytic transmembrane;

FIGS. 9a-9b are section and plan views of an exemplary strip heater for heating the catalytic transmembrane; and

FIGS. 10a through 10h are different configurations of material catalysts in the membrane pores.

### DETAILED DESCRIPTION OF THE INVENTION

The present invention provides a system and method for growing nanotubes out of carbon and other materials using CVD that facilitates sustained rapid growth of high quality nanotubes with greater control over the geometry of the nanotubes and nanotube arrays, ability to control defects in the nanotubes and the capability to observe nanotube growth using electron gun and optical equipment in-situ.

Efforts to improve the growth of CNTs have revealed a number of drawbacks in the conventional CVD approach. The surface area for absorbing carbon atoms is limited by the desired geometry and growth of the CNT from the catalytic nano-particle. To grow a SWNT the nano-particle must be very small, approximately 1-10 nm in diameter. The presence of the growing CNT further reduces the available surface area. Furthermore, the absorption process itselfcauses the surface of the catalytic nano-particle to become encrusted with amorphous carbon and graphite which slows and eventually stops absorption of feedstock carbon and growth of the CNT. The effectiveness of the scrubber gas to clean the surface of the nano-particle is limited because the scrubber gas tends to attack the CNT necessitating a lower concentration of scrubber gas. The conventional process cannot be sustained indefinitely, which places a limit on the length of CNT growth. Likewise the growth rate in the conventional process is limited by the absorption rate and a viscous force produced by the process gases that opposes the extrusion force. Growth rate will be important to commercialization of CNTs. In theory, the CNT structure is formed of pure carbon atoms. However, in the conventional process CNT growth in the presence of the impurities in the process gases can introduce contaminants into the CNT structure of 2% or more. Furthermore, the high-pressure noxious gas environment is not hospitable to in-situ annealing of defects using electron guns or in-situ observation of CNT growth using electron gun microscopes or optical sensors.

As we have discovered, many of these deficiencies are attributable to the fact that in conventional CVD , the catalytic surface at which absorption of carbon feedstock takes place and at which growth of the CNTs occurs are one and the same. However, the desired conditions for absorption of reactive carbon atoms into the catalytic material and for growth of CNTs are quite different. For efficient absorption, a system should provide a relatively large unobstructed and clean absorption surface on which to absorb the reactive carbon. The chamber would preferably be operated at higher pressure and higher concentrations of scrubber gas to keep the surface clean to sustain growth indefinitely. For efficient growth, a system should provide a growth surface that is not exposed to the growth or scrubber gases and which may be controlled to provide a small or no opposing viscous force. The system would preferably be conducive to the introduction of electron guns and optical sensors in-situ to control defects in the growing CNT and observe the growth of the CNT. In-situ observation of CNT growth is particularly important to further the science of CNT growth.

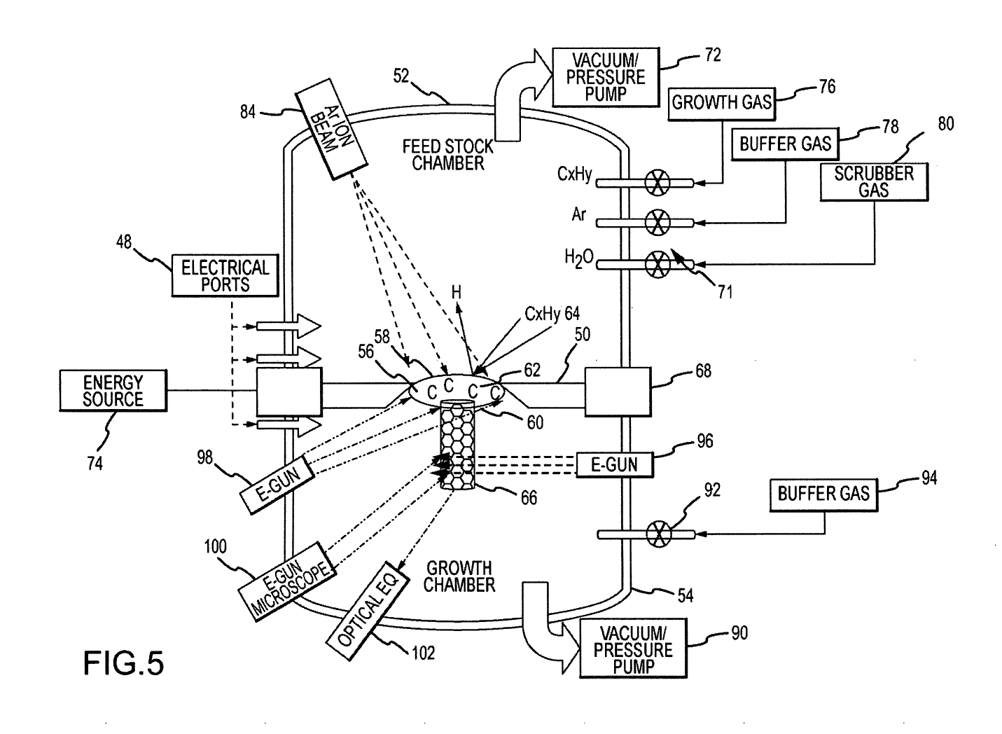

As shown in FIG. 4, the current invention provides a means to independently optimize both absorption and growth using a catalytic transmembrane 50 that separates a feedstock chamber 52 from a growth chamber 54 and provides a catalyst 56 (a ‘nano-particle’) with separate absorption and growth surfaces 58, 60 to absorb reactive carbon atoms 62 from carbon-containing molecules 64 in the feedstock chamber and to grow carbon nanotubes 66 in the growth chamber. The catalyst or nano-particle is typically a single 3D particle but could be multiple nano-particles of varying geometry and configurations. Separation of the feedstock 52 and growth 54 chambers and of the absorption 58 and growth 60 surfaces provides for greater flexibility to independently control both the gas environment and pressure in the chambers for efficient absorption and growth and to provide instrumentation in the growth chamber for in-situ control of defects or observation of the carbon nanotube growth. Note, the illustrations are not to scale; the membrane diameter is typically in the tens of millimeters while the nano-particle is at most tens of nanometers.

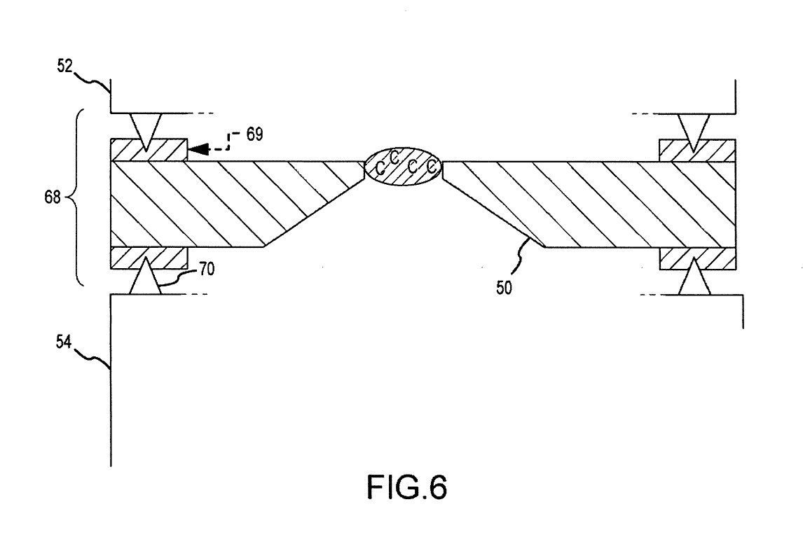

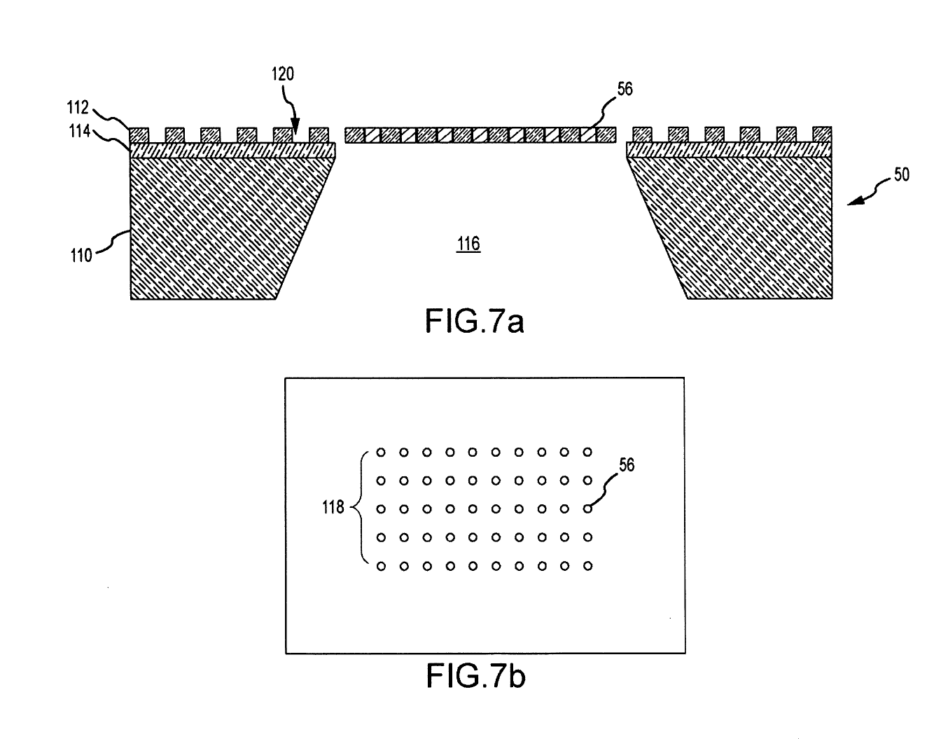

An embodiment of a system for CVD synthesis of CNTs is illustrated in FIG. 5. Catalytic transmembrane 50 separates feedstock chamber 52 from growth chamber 54 and provides catalytic nano-particle 56 with separate absorption and growth surfaces 58, 60 to absorb reactive carbon atoms 62 from carbon-containing molecules 64 in the feedstock chamber and to grow carbon nanotubes 66 in the growth chamber. A gasket 68 holds transmembrane 50 in place and environmentally seals the feedstock and growth chambers from each other and the external environment. As shown in FIG. 6, in one embodiment gasket 68 includes a soft gold ring 69 on opposite sides and along the periphery of the transmembrane and conflat (CF) vacuum flanges, knife edge (304 SS) 70 on opposing faces of the feedstock and growth chambers 52, 54. The CF vacuum flanges 70 engage the soft gold rings 69 to form the requisite seals. Other gasket configurations are possible as well. This allows the environments, namely the gas compositions and pressure, to be independently controllable. Given the ‘thinness’ of the transmembrane the differential pressure cannot be allowed to get too high. The transmembranes currently being tested are specified to withstand a differential pressure of up to 1 atmosphere (760 Torr).

A feedstock environmental control system includes gas feeds 71 to introduce process gases into the feedstock chamber 52, a pump system 72 including a vacuum and/or pressure pump to control the pressure of the feedstock chamber, and an energy source 74 to heat the gases and/or catalytic material to separate carbon atoms 62 from the growth gas molecules 64 for absorption into the catalytic material at absorption surface 58. The process gas typically includes a mixture of a carbon-containing growth gas 76, typically a hydrocarbon CₓH_{y} such as Ethylene (C₂H₄), Methane (CH₄), Acetylene (C₂H₂) or Ethanol (C₂H₅OH) or possibly a non-hydrocarbon such as carbon-monoxide (CO), a buffer gas 78 such as an inert gas, e.g. Argon (Ar), to control pressure inside the chamber and prevent released hydrogen atoms from exploding, and possibly a scrubber gas 80 such as H₂O or O₂ to periodically clean the surface of the catalyst. In some applications the buffer and or scrubber gases may not be required. A number of electrical ports 82 are provided to accommodate pressure sensors, thermocouples and the like to monitor conditions inside both chambers.

Because the CNT is not grown inside feedstock chamber 52 the CVD process can be modified for more efficient absorption and growth control. First, the concentration of the scrubber gas 80 can be increased from less than 1% from conventional CVD to greater than 10% without the risk of attacking the CNT. As a result, the unobstructed absorption surface 58 can be cleaned and the process sustained indefinitely. In an alternate embodiment, an Ar ion beam 84 can be used to clean the absorption surface. The ion beam is suitably generated external to the chamber and routed through a port in the chamber. Second, the chamber pressure can be elevated, typically 0.1 to 100 Torr, to increase the supply of carbon atoms and improve absorption of carbon atoms into the catalytic material.

A growth environmental control system includes a pump system 90 including a vacuum and/or pressure pump to control the pressure of growth chamber 54 and possibly one or more gas feeds 92 to introduce a gas 94 such as an inert gas or possibly functionalizing gases for attaching doping materials to CNTs to modify or enhance their mechanical, electrical, optical, or chemical properties for further processing into electronic or sensor devices. Eliminating the hot noxious gases, particularly the carbon-containing growth gas, from the growth chamber has several benefits. First, these gases tend to attack and contaminate the CNT as it grows. The contaminant level can be reduced to less than 1% for the configuration shown here. Second, electron guns 96 and 98 can be used in-situ to selectively fix and create defects in the CNT as it grows. Electron gun 96 can be used to anneal defects in the NT structure to provide missing carbon atoms. Electron gun 98 can be used, for example, to rotate pairs of common atoms to move the bonds and change the bond structure of the CNT. Lastly, the environment facilitates in-situ observation of the growth process using, for example, an electron microscope 100 and optical equipment 102 for Raman spectroscopy, fluorescent spectroscopy or other appropriate measurements. The electron guns and observation equipment are suitably located outside the chamber and routed through ports in the chamber.

The growth chamber may be operated in a vacuum or gases may be introduced and the pressure controlled to be nearer atmospheric pressure. Pure vacuum is 0 Torr, less than 10⁻⁶ is considered to be ultra-high vacuum and less than 10⁻² a good vacuum. For example, if the transmembrane is sufficiently strong or the feedstock chamber can be operated at a low enough pressure, a vacuum can be pulled (created) on the growth chamber. Vacuum conditions may provide an optimal environment for carbon growth and for use of the electron guns. Alternately, an inert gas can be introduced into the growth chamber to lower the pressure differential across the transmembrane. The inert gas can be selected to be a different inert gas such as He than that used in the feedstock chamber to provide a lower viscous force to resist extrusion of the carbon atoms and/or to provide better optical absorption properties for observation of carbon growth.

For simplicity of explanation, the catalytic transmembrane has been described as having a single catalyst or nano-particle embedded therein. For purposes of scientific research and some commercial applications it may be desirable to grow a single CNT. In other cases, it may be desirable to grow an array of CNTs and in some cases a very large array, perhaps upwards to billions of separate NTs in a single structure. The transmembrane is well suited for either single CNTs or arrays of CNTs. The ‘pore’ structures in which the catalysts (nano-particles) are formed can be controlled using standard processing techniques. As will be discussed later, this allows for control over the geometry of the nano-particle and particularly the geometry of the absorption and growth surfaces. In conventional CVD, drops of catalytic material are formed on the surface of the support making it difficult to control the individual drops and overall array.

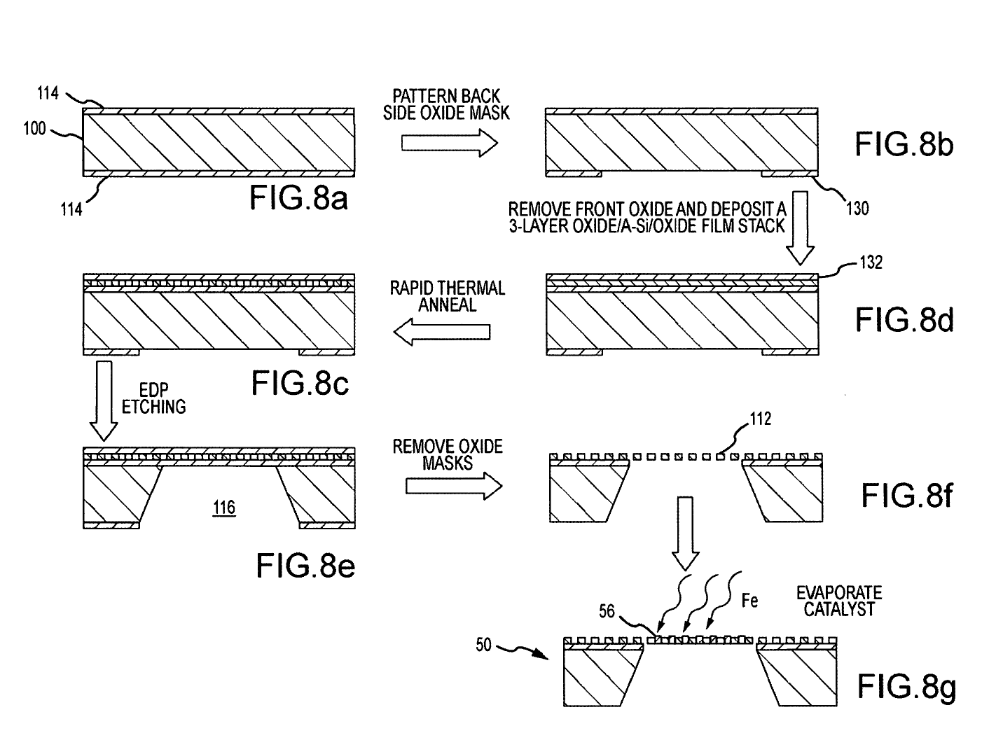

In one embodiment as shown in FIG. 7a, transmembrane 50 includes a relatively thick substrate 110 formed of a materially such as Si, SiO₂, or Al₂O₃ that is chemically inactive to the nanotube material. The substrate should be sufficiently strong to handle pressure gradients between the feedstock and growth chambers and exhibit thermal expansion properties close to the catalytic material. A porous layer 112 is supported on an oxide layer 114 over a cavity 116 in substrate 110. At higher temperatures the oxide layer may prevent diffussion of atoms from the substrate into the catalysts. As shown in FIG. 7b, porous layer 112 includes an array 118 of pores 120 approximately 0.5-100 nm in diameter. The catalytic nano-particles 56 are embedded in pores 120. The porous layer is very thin, typically 50-1000 nm. The outer diameter of the membrane is typically 10-100 mm. For certain substrate materials (silicon), the inner diameter of the exposed portion of the porous layer is suitably small, 10-200 microns, so that the porous layer itself can handle the expected pressure gradients. For other materials such as alumina the transmembrane can have uniform thickness. Other transmembrane configurations that provide the requisite functionality of separating and sealing the feedstock and growth chambers and providing different catalytic surfaces for absorption and growth are contemplated by the current invention.

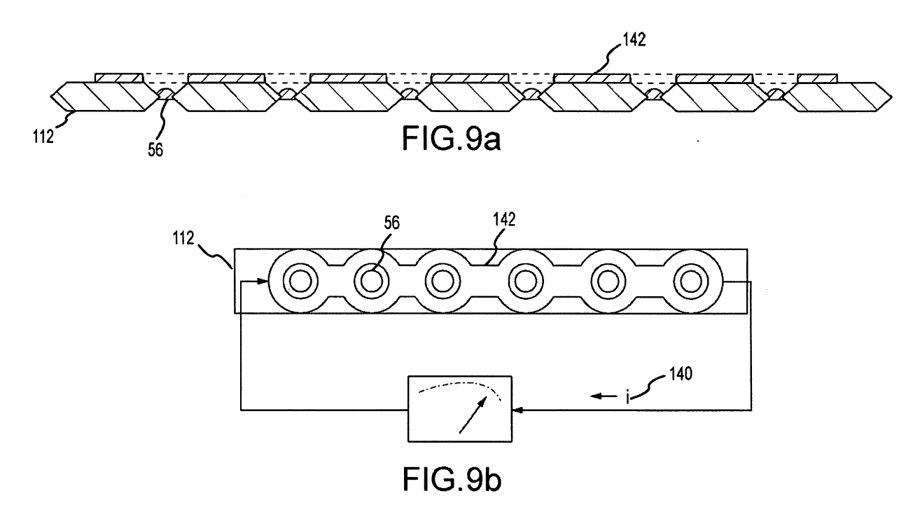

A method of fabricating transmembrane 50 is illustrated in FIGS. 8a through 8g. For convenience, we start with a porous nano-crystalline silicon (pnc-Si) membrane of the type described by Christopher Stiemer et al. “Charge- and size-based separation of macromolecules using ultrathin silicon membranes” NATURE, Vol. 445, 15 Feb. 2007, pp. 749-753 for filtration of nanoparticles from approximately 5 nm to 25 nm and evaporate catalytic material such as Fe into the pores to form the catalytic nano-particles. Other methods of forming the transmembrane are contemplated by the current invention.

In an exemplary embodiment, a 500 nm thick layer 114 of SiO₂ is grown on both sides of a silicon wafer 110. On the backside of the wafer, the SiO₂ is patterned using standard photolithography techniques to form an etch mask 130 for the membrane formation process. The frontside oxide is then removed, and a high quality three layer film stack 132 (20 nm SiO₂/15 nm a-Si/20 nm SiO₂) is deposited on the front surface using RF magnetron sputtering. To form the pnc-Si membranes, the substrate is briefly exposed to high temperature in a rapid thermal processing chamber, crystallizing the a-Si into a nanocrystalline film thereby forming the pores. The patterned wafer back side is then exposed to a highly selective silicon etchant, EDP, which removes the silicon wafer along crystal planes until it reaches the first SiO₂ layer of the front side film stack to form cavity 116. Exposing the three layer membrane to buffered oxide etchant removes the protective oxide layers, leaving the freely suspended ultra thin pnc-Si membrane 112. Thereafter, iron is evaporated at high temperature, which, upon heating, forms droplets that are drawn into the pores via capillary action leaving a catalytic transmembrane whose pores are sealed with catalytic material 56. Many other methods to fill the nm pores can be found in the scientific literature dealing with nano capillarity such as solution evaporation and sublimination methods, sputtering or atomic layer deposition, or electrolytic deposition.

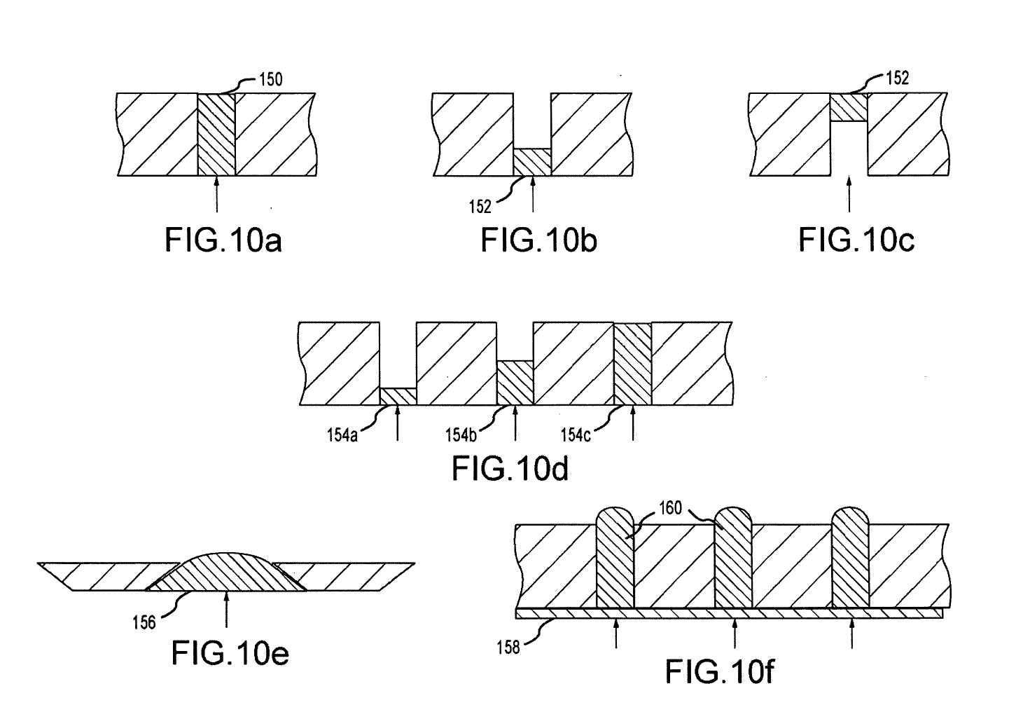

As described above, an energy source is used to heat the catalytic material and/or growth gas to ‘crack’ the molecules and provide the reactive carbon atoms and to maintain the temperature needed for absorption into and bulk or surface diffussion through the catalytic material. In general, this can be done with a heat source that heats the transmembrane and/or the process gases. Within the sealed chamber, heating the process gases will have the effect of heating the catalytic material and vice-versa. As shown in FIGS. 9a and 9b, provision of an electrical current 140 through a resistive heater strip 142 patterned around the individual nano-particles 56 on porous layer 112 can maintain the transmembrane at a constant temperture. The integrated heater strip may be more effective at maintaining the entire array of nano-particles at the desired temperature. One of the electron guns in the growth chamber can locally heat the growth region so that growth is stimulated.

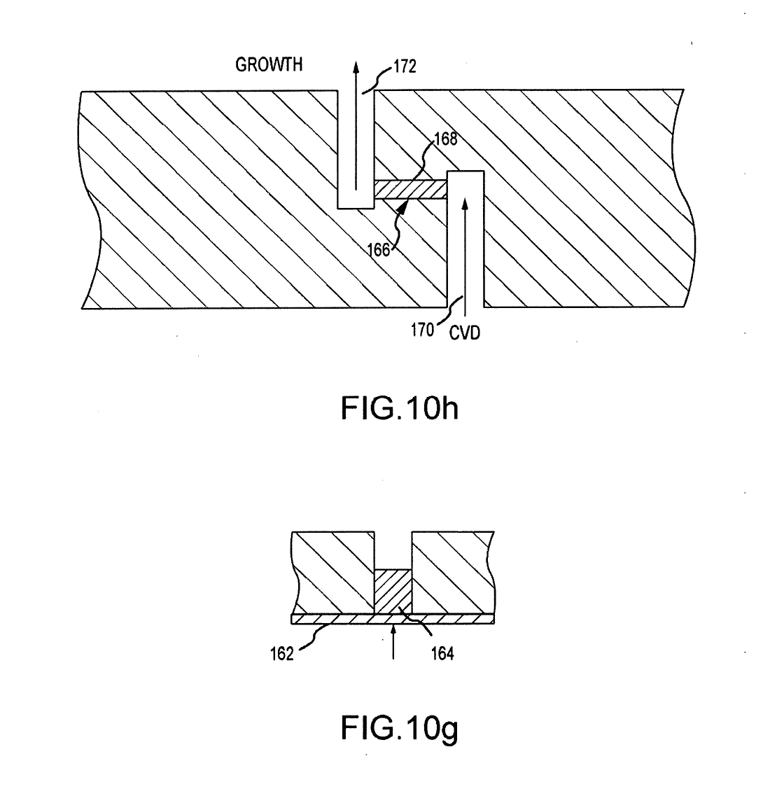

Another potential benefit to the use of the catalytic transmembrane is the capability to control the geometry of the nano-particle(s) and more particularly the geometry of the particle's absorption and growth surfaces that are exposed to the feedstock and growth chambers, respectively. This may be used to improve the efficiency of absorption and growth and to control the geometry of the CNT. As illustrated in FIG. 10a a typical nano-particle 150 might fill the pore and present absorption and growth surfaces having the same surface area and curvature. As illustrated in FIGS. 10b and 10c a nano-particle 152 may fill only a portion of the pore and be positioned at the membrane-feedstock interface or the membrane-growth interface, respectively (or somewhere in between). As illustrated in FIG. 10d the nano-particles 154a, 154b, and 154c are varied in height across the array. Growth of the CNT may be influenced by varying the thickness of the nano-particle and its position in the pore. As shown in FIG. 10e, the absorption surface of nano-particle 156 is flat and considerably larger than the curved growth surface. The growth surface may be constrained to a certain maximum diameter to grow a SWNT. This geometry provides for a larger absorption surface to absorb carbon atoms to feed the growth process. As depicted in FIG. 10f, a layer 158 of catalytic material is formed on the backside of nano-particles 160. This can also have the effect of increasing the surface area for absorbing carbon atoms. It may also have the beneficial effect of making the absorption of carbon across the array more uniform. A similar effect may be achieved by forming an inactive layer 162 of material that although itself not a catalyst is effective at absorbing carbon atoms and transferring them to the catalytic nano-particle 164 as shown in FIG. 10g. At an atomic level, the reactive carbon atoms from the growth gas are still hitting the absorption surface of the nano-particle, thus the nano-particle is ‘exposed’ to the feedstock chamber. As shown in FIG. 10h, the pore 166 does not form a direct through-hole in the membrane. The nano-particle 168 formed in pore 166 lies in the plane with an absorbing surface open to a partial hole 170 to the feedstock chamber and a growth surface open to a partial hole 172 to the growth chamber. By avoiding through-holes that extend all the way through the membrane this configuration may be stronger. Many other configurations for individual pores and arrays of pores are contemplated by the invention.

The following examples exemplify the flexibility provided by independent feedstock and growth chambers. However, there are many variations on the transmembrane configuration and feedstock and growth parameters that may be used.

### Case 1:

Transmembrane: 400 micron thick silicon with approximately 1 million 10 nm diameter pores filled with Fe.

Feedstock Chamber: 10-45% Ethylene growth gas, 30-85% Argon buffer gas (purged before growth or introduced continuously), 5-25% Hydrogen scrubber gas (purged before growth or introduced continuously), 1E⁻¹ to 1E⁺² Torr, 500-900 C.

Growth Chamber: Vacuum (<1E⁻²) or Argon/Helium inert gases at 1E⁻¹ to 1E⁺² Torr

### Case 2:

Transmembrane: 400 micron thick silicon with approximately 1 million 10 nm diameter pores filled with Fe.

Feedstock Chamber: 15-100% Ethanol growth gas, 75-90% Argon buffer gas (purged before growth or introduced continuously), 5-25% Hydrogen scrubber gas (purged before growth or introduced continuously), 1E⁻¹ to 1E⁺² Torr, 500-900 C.

Growth Chamber: Vacuum (<1E⁻²) or Argon/Helium inert gases at 1E⁻¹ to 1E⁺² Torr

### Case 3:

Transmembrane: 20-100 micron thick alumina with approximately 1 trillion 13-18 nm diameter pores filled with Fe.

Feedstock Chamber: 10-45% Ethylene growth gas, 30-85% Argon buffer gas (purged before growth or introduced continuously), 5-25% Hydrogen scrubber gas (purged before growth or introduced continuously), 1E⁻¹ to 1E⁺² Torr, 500-900 C.

Growth Chamber: Vacuum (<1E⁻²) or Argon/Helium inert gases at 1E⁻¹ to 1E⁺² Torr

### Case 4:

Transmembrane: 20-100 micron thick alumina with approximately 1 million 10 nm diameter pores filled with Fe.

Feedstock Chamber: 15-100% Ethanol growth gas at 5-20 Torr, 75-90% Argon buffer gas (purged before growth or introduced continuously), 5-25% Hydrogen scrubber gas (purged before growth or introduced continuously), 1E⁻¹ to 1E⁺² Torr, 500-900 C.

Growth Chamber: Vacuum (<1E⁻²) or Argon/Helium inert gases at 1E⁻¹ to 1E⁺² Torr

Although the description of the invention has focused on the growth of carbon nanotubes the approach is viable for growing nanotubes from other materials such as Germanium (Ge), Boron (B), or Boron-Nitride (BN). The interest in and development of carbon nanotube technology is well beyond that of other materials, hence the focus on carbon nanotubes. However, the approach of using a catalytic transmembrane to separate the feedstock and growth chambers is just as applicable for growing nanotubes from these other discovered or yet to be discovered materials.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. An apparatus for growing carbon nanotubes using chemical vapor deposition (CVD), comprising a catalytic transmembrane that separates a feedstock chamber from a growth chamber, said transmembrane having a catalyst embedded therein with portions of catalyst surface exposed to the feedstock chamber for absorbing carbon atoms from a carbon-containing growth gas and different portions of catalyst surface exposed to the growth chamber to grow carbon nanotubes.

2. The apparatus of claim 1, wherein the gas composition and pressure within the feedstock and growth chambers are independently controllable.

3. The apparatus of claim 2, wherein the carbon-containing growth gas is not present in the growth chamber.

4. The apparatus of claim 2, further comprising:
a growth environmental control system including a first pump system to control the pressure of the growth chamber; and
a feedstock environmental control system including,
a second pump system to control the pressure of the feedstock chamber,
a gas feed to introduce process gases including at least the growth gas into the feedstock chamber, and
a heating element to heat the gases and/or catalytic material to separate carbon atoms from the growth gas for absorption into the catalytic material.

5. The apparatus of claim 4, further comprising:
a second gas feed to introduce a scrubber gas into the feedstock chamber to clean the absorbing surface of the catalytic material

6. The apparatus of claim 4, wherein said control systems provide a relatively high pressure and a relatively low pressure environment in said feedstock and growth chambers, respectively, to accelerate absorption of carbon into the catalytic material and to reduce viscous forces to accelerate growth of the carbon nanotubes.

7. The apparatus of claim 2, further comprising:
at least one electron gun that directs an electron beam into said growth chamber to control defects in the carbon nanotubes.

8. The apparatus of claim 2, further comprising:
at least one electron gun that directs an electron beam into said growth chamber to characterize properties of the carbon nanotube.

9. The apparatus of claim 2, further comprising:
at least one optical device that characterizes the carbon nanotube in said growth chamber.

10. The apparatus of claim 1, wherein the geometry of the portions of the catalyst surface is configured for efficient absorption of carbon atoms and the geometry of the different portions of the catalyst surface is configured to grow carbon nanotubes with a specified geometry.

11. The apparatus of claim 10, further comprising an in active layer of carbon absorbing material on the transmembrane that transfers carbon atoms from the feedstock chamber to the portions of the catalyst surface that absorb the carbon atoms.

12. The apparatus of claim 1, wherein said catalytic transmembrane includes an array of catalysts embedded therein to grow an array of carbon nanotubes in said growth chamber.

13. The apparatus of claim 12, wherein the geometry of the catalysts varies across the array.

14. The apparatus of claim 12, further comprising a layer of catalytic material over the transmembrane on the feedstock side that connects the catalysts.

15. An apparatus for growing nanotubes using chemical vapor deposition (CVD), comprising:
a chamber;
a transmembrane having an array of catalytic nano-particles with opposing absorption and growth surfaces embedded therein, said transmembrane separating said chamber into a feedstock chamber and a growth chamber in which the pressure and gas environments are independently controllable;
a growth environmental control system including a first pump system to control the pressure of the growth chamber; and
a feedstock environmental control system including,
a second pump system to control the pressure of the feedstock chamber,
a plurality of gas feeds to introduce process gases including a growth gas, a buffer gas and a scrubber gas into the feedstock chamber, said scrubber gas being introduced to clean the nano-particles' absorption surface, and
a heating element to heat the gases and/or catalytic material to separate reactive atoms from the growth gas for absorption into the catalytic nano-particles at their absorption surface to grow an array of nanotubes at their growth surfaces.

16. The apparatus of claim 15, wherein the growth gas is not present in the growth chamber.

17. The apparatus of claim 15, wherein said control systems provide a relatively high pressure and a relatively low pressure environment in said feedstock and growth chambers, respectively, to accelerate absorption of reactive atoms into the catalytic material and to reduce viscous forces to accelerate growth of the nanotubes.

18. The apparatus of claim 15, further comprising:
at least one electron gun that directs an electron beam into said growth chamber to control defects in the nanotubes.

19. The apparatus of claim 15, further comprising:
at least one electron gun that directs an electron beam into said growth chamber to characterize properties of the nanotubes.

20. The apparatus of claim 15, wherein the geometry ofthe nano-particles' absorption surface is configured for efficient absorption of atoms and their growth surface is configured to grow nanotubes with a specified geometry.

21. The apparatus of claim 15, wherein the atoms in the growth gas that form the nanotubes are selected from one of Carbon, Germanium, Boron, or Boron-Nitride.

22. A method for growing nanotubes via chemical vapor deposition, comprising:
separating a feedstock chamber from a growth chamber by a transmembrane, said transmembrane having catalytic material embedded therein;
introducing a process gas mixture including at least a growth gas into the feedstock chamber;
controlling the growth chamber to be devoid of at least the growth gas; and
heating the process gases and/or catalytic material in the feedstock chamber to separate reactive atoms from the growth gas so that the atoms are absorbed into the catalytic material at an absorption surface causing nanotubes to grow at a different growth surface in the growth chamber.

23. The method of claim 22, further comprising:
controlling the pressure of the feedstock and growth chambers, respectively, to increase absorption of atoms from the growth gas into the catalytic material and to increase the rate of growth of nanotubes from the catalytic material.

24. The method of claim 22, further comprising:
directing an electron beam into the growth chamber to control defects in the nanotube or to characterize the nanotube.

25. The apparatus of claim 22, wherein the atoms in the growth gas that form the nanotubes are selected from one of Carbon, Germanium, Boron, or Boron-Nitride.

26. An apparatus for growing nanotubes using chemical vapor deposition (CVD), comprising a catalytic transmembrane that separates a feedstock chamber from a growth chamber, said transmembrane having a catalyst embedded therein with portions of catalyst surface exposed to the feedstock chamber for absorbing reactive atoms from a growth gas and different portions of catalyst surface exposed to the growth chamber to grow nanotubes.

27. The apparatus of claim 24, wherein the atoms that form the nanotubes are selected from one of Carbon, Germanium, Boron, or Boron-Nitride.
